(19) United States
(12) Patent Application Publication
(10) Pub. No.: US 2025/0267450 A1
(43) Pub. Date: Aug. 21, 2025

(54) PROCESSING

(71) Applicant: NICOVENTURES TRADING LIMITED, London (GB)

(72) Inventors: Nejat ERGUVEN, London (GB); Danilo PETRONE, Milano (IT); Roberto PELLEGRINI, Milano (IT); Alessandro VALENTE, Milano (IT)

(21) Appl. No.: 18/858,376

(22) PCT Filed: Apr. 20, 2023
(86) PCT No.: PCT/GB2023/051039

§ 371 Date: Oct. 21, 2024

(30) Foreign Application Priority Data
Apr. 22, 2022 (GB) 2205929.9

(51) Int. Cl. H04W 12/02; A24F 40/65; H04W 12/033

(52) U.S. Cl. CPC H04W 12/02; A24F 40/65; H04W 12/033

(57) ABSTRACT

There can be provided a method that comprises collecting, at a device, user-specific data relating to an aerosol provision device of a user. The method can further comprise transmitting the user-specific data to a remote system in association with a hashed user ID for the user of the aerosol provision device, wherein the hashed user ID is not usable to identify the user.

### BACKGROUND

The present disclosure relates to processing, and in particular but not exclusively to processing of data such as to anonymise user-specific data to permit the data to be used for bulk data analysis.

In some device implementations, a device may collect data about its own use, and such data about use of each of many such devices is then collected by some form of monitoring system. At the monitoring system, the various data may be collated, analysed or otherwise processed in order for information about the devices as a collective group to be determined. Such information may have utility for diagnostic purposes, product development purposes or the like.

Known approaches are described in WO2021165425A1, US2014325592A1, US2011078779A1, WO2021059210A1 and US2016164847A1.

### SUMMARY

Viewed from a first perspective, there has been provided a method that comprises: collecting, at a device, user-specific data relating to an aerosol provision device of a user; transmitting the user-specific data to a remote system in association with a hashed user ID for the user of the aerosol provision device, wherein the hashed user ID is not usable to identify the user. Thus user-specific data may be shared in anonymous manner while retaining its user-specific nature.

Viewed from a second perspective, there has been provided a user device configured to: collect user-specific data relating to an aerosol provision device of a user; transmit the user-specific data to a remote system in association with a hashed user ID for the user of the aerosol provision device, wherein the hashed user ID is not usable to identify the user.

Viewed from a further perspective, there has been provided a data management system, that comprises a user device and a connectivity platform, wherein the user device is configured to collect user-specific data relating to an aerosol provision device of a user, and to transmit the user-specific data to the connectivity platform in association with a hashed user ID for the user of the aerosol provision device, wherein the hashed user ID is not usable to identify the user.

### BRIEF DESCRIPTION OF FIGURES

Embodiments and examples of the present approaches will now be described, by way of example only, with reference to the accompanying drawings, in which:

FIG. 1a shows a schematic indication of a device environment in which sharing of user-specific data may be performed.

FIG. 1b shows a schematic indication of how data sharing may be achieved in an anonymised manner.

FIG. 2 shows a process by which user-specific data may be shared in an anonymised manner.

FIG. 3 shows a process by which a lost user code may be reset while respecting anonymization of shared data.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

In this disclosure, a “non-combustible” aerosol provision system is an aerosol provision system where a constituent aerosol-generating material of the aerosol provision system (or component thereof) is not combusted or burned in order to facilitate delivery of at least one substance to a user.

The non-combustible aerosol provision system may be an electronic cigarette, also known as a vaping device or electronic nicotine delivery system (END), although it is noted that the presence of nicotine in the aerosol-generating material is not a requirement.

The non-combustible aerosol provision system may be an aerosol-generating material heating system, also known as a heat-not-burn system. An example of such a system is a tobacco heating system.

The non-combustible aerosol provision system may be a hybrid system to generate aerosol using a combination of aerosol-generating materials, one or a plurality of which may be heated. Each of the aerosol-generating materials may be, for example, in the form of a solid, liquid or gel and may or may not contain nicotine. The hybrid system may comprise a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

The non-combustible aerosol provision system, such as a non-combustible aerosol provision device thereof, may comprise a power source and a controller. The power source may, for example, be an electric power source or an exothermic power source. The exothermic power source comprises a carbon substrate which may be energised so as to distribute power in the form of heat to an aerosol-generating material or to a heat transfer material in proximity to the exothermic power source.

The non-combustible aerosol provision system may comprise an area for receiving the consumable, an aerosol generator, an aerosol generation area, a housing, a mouthpiece, a filter and/or an aerosol-modifying agent.

The consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

The present approaches relate to interactions between various entities for sharing of data therebetween. According to the present approaches, such data sharing is performed in a manner that anonymises the data such that once shared the data no longer includes information about a specific user, while permitting the shared data to nonetheless be analysed or processed on a per-source basis.

According to the present approaches, a user (sometimes termed a device owner and/or an account holder) is able to control the data content that they are willing to share and is also maintains ownership of information that links their own identity to the shared data.

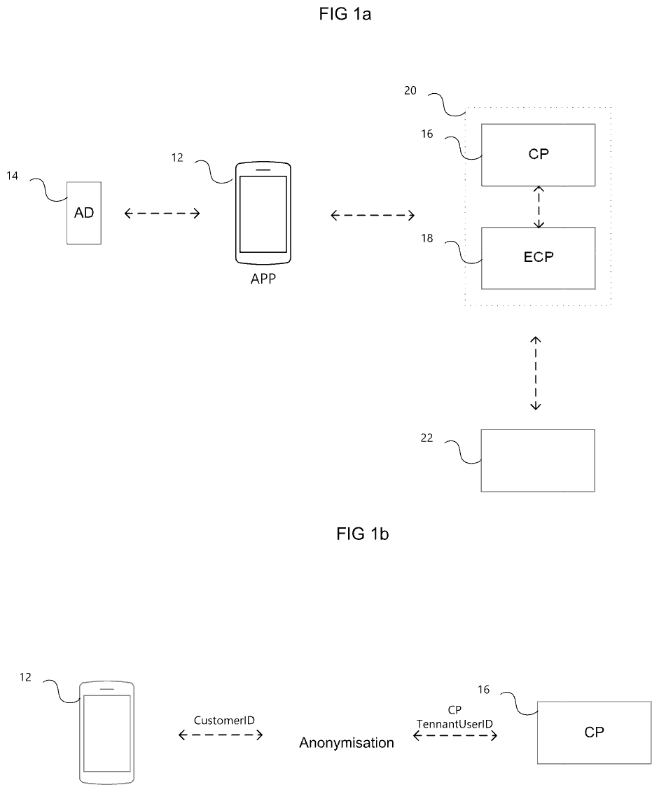

As illustrated in FIG. 1a, an device, such as an aerosol provision device “AD” 14 has a data connection to a user device 12 running software (sometimes termed an application and/or an app) using a processor and memory of the user device for interfacing with the aerosol provision device 14. The user device 12 may be generally referred to as “APP” to represent that the functionality can be provided at any suitable user device. The aerosol provision device 14 may be a non-combustible aerosol provision device operable in combination with a consumable as an aerosol provision system. The user device 12 as illustrated in FIG. 1 may be a mobile telephone, but in general the user device 12 may be any personal processing device which can communicate with the aerosol device and other entities as described below. Examples of suitable personal processing devices include a mobile telephone (cellphone), a PDA, a tablet device, a phablet device, a netbook computer, a laptop computer or a desktop computer.

The data connection between the user device 12 and aerosol provision device 14 in the present examples is a wireless channel provided using a connectivity technology such as a personal area network protocol. Example personal area network protocols include Bluetooth™, Bluetooth Low Energy™ (BLE), Zigbee™, Wireless USB, and Near-Field Communication (NFC). Example personal area network protocols also include protocols making use of optical communication such as Infrared Data association (IrDA) and data-over-sound. The remainder of this discussion will use the example of BLE and will use BLE terminology, although it will be appreciated that corresponding or equivalent functionalities of other personal area network technologies may be substituted. Other wireless technologies such as a Wi-Fi™ technology may be used if the aerosol provision device has suitable capability. In other examples, the local communication channel 16 may be a wired communication channel provided between physical ports of the aerosol provision device 14 and the user device 12. Such a wired communication channel may utilise a physical connection technology such as USB™, a serial port, FireWire™ or other point-to-point wired connectivity. As will be appreciated such a data connection may be established on an intermittent basis such that data can only be transferred from the aerosol provision device 14 to the user device 12 when the connection is active, in such cases the aerosol provision device may store data locally pending transfer of such data to the user device 12.

Data transferred from the aerosol provision device 14 to the user device 12 may include status information about the aerosol provision device and/or usage information about the aerosol provision device 14. Such status may include any of current battery level, amount of consumable remaining, charging status (e.g. whether or not charging is in progress, existence of charging start and/or charging end event etc), visual feedback indicator settings, haptic feedback indicator settings, audible feedback indicator settings or the like. Such usage information may include any of puff duration of a given puff, puff strength of a given puff, average puff duration over a puff session or time period, average puff strength over a puff session or given time period, number of puffs or puff sessions over a given time period, heater power setting for one or more puffs, heater power duration for one or more puffs, or the like.

The user device 12 may store such data transferred from the aerosol provision device 14 in a memory of the user device 12 in a manner controlled or defined by the app and/or an operating system of the user device 12. The user device 12 may also record and store further data relating to the user and/or the aerosol provision device 14. Such data may include any of a position of the user device 12 when certain data is received or recorded, a date on which certain data is received or recorded, a time at which certain data is received or recorded, a date on which an order was placed for additional consumables, a date on which additional consumables are expected to be received, a date at which the aerosol provision device was last connected to the user device, a time at which the aerosol provision device was last connected to the user device, or the like.

Collectively, all such data collected by either or both of the aerosol provision device 14 and the user device 12, which may be stored by the user device 12, are termed user-specific data as all such data are specific to a user operating the aerosol provision device 14 and the user device 12 and will be associated with a particular user identity. As explained below, the particular user identity (or user-ID) may be represented by an identifier utilised by the user to access a platform provided by a supplier of the aerosol provision device 14 and/or operator of online services relating to the aerosol provision device. For the purposes of the present illustrations this identifier is termed “CustomerID”, although the particular name or representation of the identifier may be altered according to the requirements of any particular implementation.

As further illustrated in FIG. 1a, the user device 12 is also in data communication with network platforms 20. The network platforms 20 include a connectivity platform 16 (which may be termed “CP”) and an operator platform 18 (which may also be termed an account platform, an e-commerce platform or “ECP”) having data connectivity therebetween. The connectivity platform and operator platform are in the present examples provided as entirely separate platforms operated by different entities. In other implementations these two platforms may alternatively be separate platforms operated by a common entity, or may be separate platforms co-hosted in a single computing environment, and/or may be a single combined platform providing the functionality of both platforms.

Either or both of the connectivity platform 16 and the operator platform 18 may be in data communication with one or more additional systems, platforms or data storage systems, collectively indicated by reference 22. For example, either or both of the connectivity platform 16 and the operator platform 18 may be implemented in a processing resource that uses a separate data storage resource (represented again by 22) for storage of data. In another example, the operator platform 18 may provide retail services to a user of the user device 12, for which purpose the operator platform may interface with an external inventory and/or shipping service (represented again by 22).

The network platforms 20, either collectively or considered individually as the connectivity platform 16 and the operator platform 18, and in some instances also including the additional systems 22, may be generally referred to as a remote system. The term remote system indicates a system (or systems) that are remote from the user device.

The data connectivity between the user device 12, connectivity platform 16, operator platform 18 and/or additional systems/platforms 22 may be provided using suitable data connectivity approaches, including for example, radio access networks, wired access networks, the Internet and the like. For instance, the user device 12 may have data connectivity to connectivity platform 16 and operator platform 18 by way of a radio access network connection from the user device 12 to a radio-access network-provider's Internet gateway, then via the Internet to a gateway for a wired network that includes either or both of connectivity platform 16 and operator platform 18.

The communication from the user device 12 to the operator platform 18 may use an API gateway for the operator platform 18 to facilitate both authentication/login and any data transfer. As mentioned above, the operator platform may be an e-commerce platform, and thus login credentials provided from the user device 12 at step S2-1 in order to log in to the operator platform may be the same as used to log in to the operator platform for e-commerce services such as ordering of consumables for use with the aerosol provision device 14, purchase of aerosol provision devices (possibly including previous purchase of the aerosol provision device 14) and/or management of a user account with the operator such as communications preferences, address changes, and other account management tasks. To facilitate a login session for the user device to the operator platform, once login is completed a session token may be issued by the operator platform for maintain the session for a given duration and/or until a certain inactivity duration has expired. In the same or similar fashion, an API gateway may be used for communication from the user device 12 to the connectivity platform 16, although in the alternative an explicit login webpage or the like may be used for connectivity from the user device to either of these systems.

The data connectivity from the user device 12 to the connectivity platform 16 may be used to share user-specific data to the connectivity platform. Likewise, the data connectivity from the user device to the operator platform 18 may be used to share user-specific data to the operator platform. In either case, the connectivity platform and/or the operator platform may store or further share the user-specific data to the additional systems/platforms 22. In addition or alternatively, the data connectivity from the user device 12 to either or both of the connectivity platform and the operator platform may be used to transmit login credentials and/or other information required for the user device to access services provided by the connectivity platform and/or the operator platform. In the present implementations, data being shared over one or more data connections is encrypted according to the appropriate circumstances, which may vary between specific implementations.

In order to protect one or more aspects of the user specific data shared by the user device 12 which it may be inappropriate to share openly in association with the specific identify of the user, in the present approaches the user device 12, connectivity platform 16 and the operator platform 18 cooperate to anonymise the user-specific data. In the present approaches, the anonymization operates to maintain the user-specific data as being specific to a single user (and/or specific to a single aerosol provision device) while concealing the identity of the specific user (and/or device) to which the user-specific data relates.

In order to provide such anonymization of the user-specific data, the present approaches create a user-specific identifier which is applied to the shared user-specific data instead of the user identifier CustomerID. The link between CustomerID and the new user-specific identifier is in general known only to the user, so as to avoid the link between Customer ID and the new user-specific identifier being reverse engineered. For the purposes of the present illustrations this new user-specific identifier is termed “CP TennantUserID”, although the particular name or representation of the identifier may be altered according to the requirements of any particular implementation.

This anonymization is illustrated in FIG. 1b, in which it is schematically shown that from the user device to an anonymization process, identification is by way of the CustomerID, whereas from the anonymization process to the connectivity platform, identification is by way of CP TennantUserID. Approaches for creating the CP TennantUserID are discussed below.

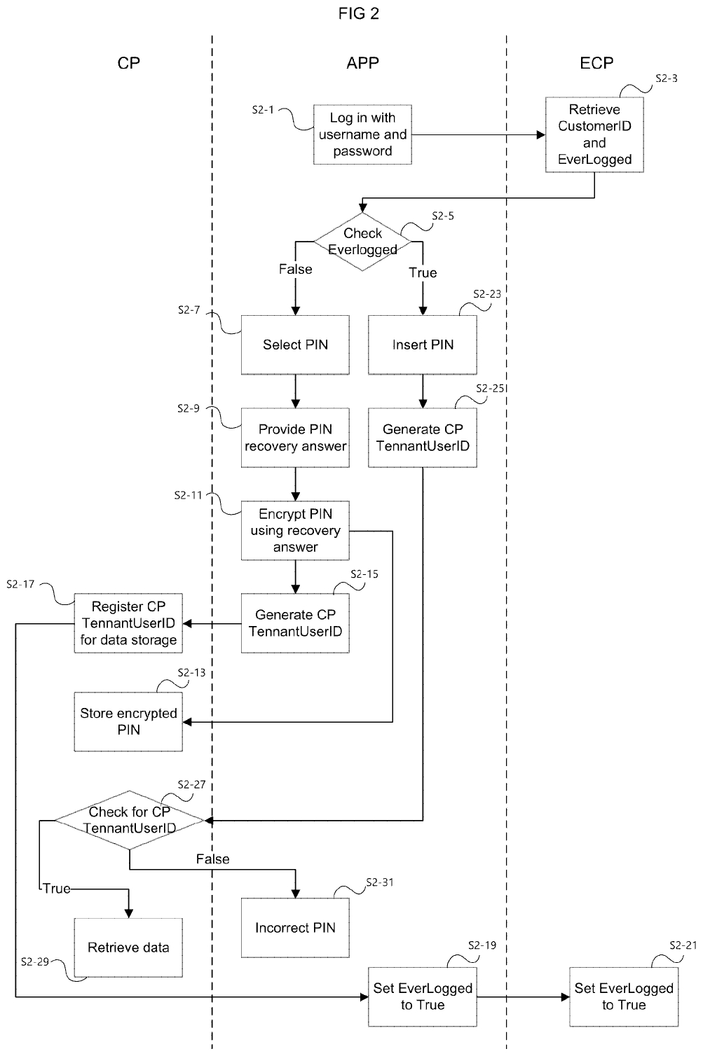

Turning now to FIG. 2, there is indicated a process by which CP TennantUserID may be generated and used for sharing user-specific data from the user device in an anonymised manner.

Starting at step S2-1, the user device (APP) 12 logs in to the operator platform (ECP) 18 using a username and password associated with a user account for the user with the operator platform. This login may be performed manually by the user entering username and password into the user device, or the user device may perform the login using stored username and password. Although indicated that this uses a username and password, other login credential approaches may be used, including for example the use of some form of two-factor authentication such as a one-time-passcode or the like.

Upon successful login to the operator platform, at step S2-3 the operator platform retrieves a CustomerID associated with the user's account, and the value of a field (named for reference purposes here “EverLogged”) indicating whether or not the user has previous logged in to the connectivity platform following generation of a CP TennantUserID. The EverLogged field may in some implementations be a single bit binary flag with a first value indicating true and the other value indicating false, although alternatives such as a longer field that indicates the nature of the field as well as its value, and/or a textual representation may be used for the EverLogged field. In some examples the EverLogged may be specific to a given time period, logins from a particular device, logins from a particular app installation or the like, such that if one of these changes the EverLogged field may be reset. The CustomerID and the state of the EverLogged field are sent from the connectivity platform to the user device.

Following receipt of the value of the EverLogged field by the user device, the user device check at step S2-5 the value of the EverLogged field.

If the EverLogged field is false, then processing continues at step S2-7 where the user is invited by the user device to set a PIN (generally referred to as a user-set code). The user-set code is typically constrained to conform to a set of specified properties, which set of specified properties can be set according to the requirements of a particular implementation. For example the set of specified properties for the user-set code could be simple such as a 4-digit number, but could be more complex such as a 5, 6, 7, 8 or more digit number, and/or could be set to include a certain length of alphanumeric characters, and/or could be set to include one or more non-alphanumeric characters, or the like.

In implementations in which it is desired to provide for recovery of a forgotten user-set code, then at step S2-9 the user is invited by the user device to provide a PIN recovery answer (which may be terms a recovery answer and/or a user-set security term). The exact form if the PIN recovery answer may vary, but in the present examples this is an answer provided by the user to one or more prompt-questions that invites a response from the user to that question. Examples of suitable prompt-questions may include an invitation to name a favourite place, a memorable event, a family member's name or the like. In other examples, the PIN recovery answer may be invited using a different form of invitation or incitement, with the exact mechanism not mattering unless the

In implementations in which it is desired to provide for recovery of a forgotten user-set code, the user-set code is then encrypted using the recovery answer at step S2-11. By encrypting the user-set code in this way, the encrypted code can then be stored at the connectivity platform 16 (or alternatively at the operator platform 18) at step S2-13 without either the code or the recovery answer being known at the storage location.

After the user-set code is provided, the user device then creates at step S2-15 a new user-specific identified “CP TennantUserID”. In the present example this is generated by hashing the CustomerID using the user-set code as a salt for the hash. Use of a salt for a hash typically involves concatenating the salt (in this case the user-set code) and the code to be hashed (in this case the CustomerID) and then performing a hash function on the concatenated whole. By using the user-set code as salt for the hash, reverse-engineering of the CustomerID from the CP TennantUserID is prevented (or at least very substantially impeded). Suitable hashing algorithms may include known cryptographic hash algorithms such as SHA-2, SHA-3, RIPEMD-160, Whirpool, BLAKE2 and BLAKE3 (although other hash algorithms may be used if desired for any particular implementation). As the CP TennantUserID is created by hashing the CustomerID, which is itself a form of user-ID, the CP TennantUserID may also be termed a “hashed user ID”.

Once the CP TennantUserID has been created, this can be shared from the user device to the connectivity platform to enable the connectivity platform to register that TennantUserID for data storage. Once this step is complete, the user device can commence sharing user-specific data to the connectivity platform using the CP TennantUserID, such that any shared data is thus known by the connectivity platform to have come from a user having that CP TennantUserID, but without the connectivity platform knowing which specific user the data has come from (as the CustomerID or any field usable to individually identify the user is not shared to the connectivity platform), such that the user-specific data is shared in an anonymised manner.

As part of registering the CP TennantUserID for data storage, the connectivity platform may assign a further code to the CP TennantUserID for internal data management purposes, such a further code (which may be termed a unique user identified or UUID). This UUID (if used) is associated with the CP TennantUserID to enable the connectivity platform to manage the shared user-specific data according to its own internal functionality, but the UUID is not associated with the CustomerID or any other field usable to individually identify the user as no such field has been shared to the connectivity platform. In some implementations, the UUID may be provided to the user device which may be of use in the event that the CP TennantUserID is at some point changed due to loss of user-set code or other reason, to enable continuity of data management for the shared user-specific data.

Once the CP TennantUserID has been registered for data storage, the connectivity platform informs the user device at step S2-19 that the EverLogged field should be set to true, and then the user device informs the operator platform at step S2-21 that EverLogged field should be set to true.

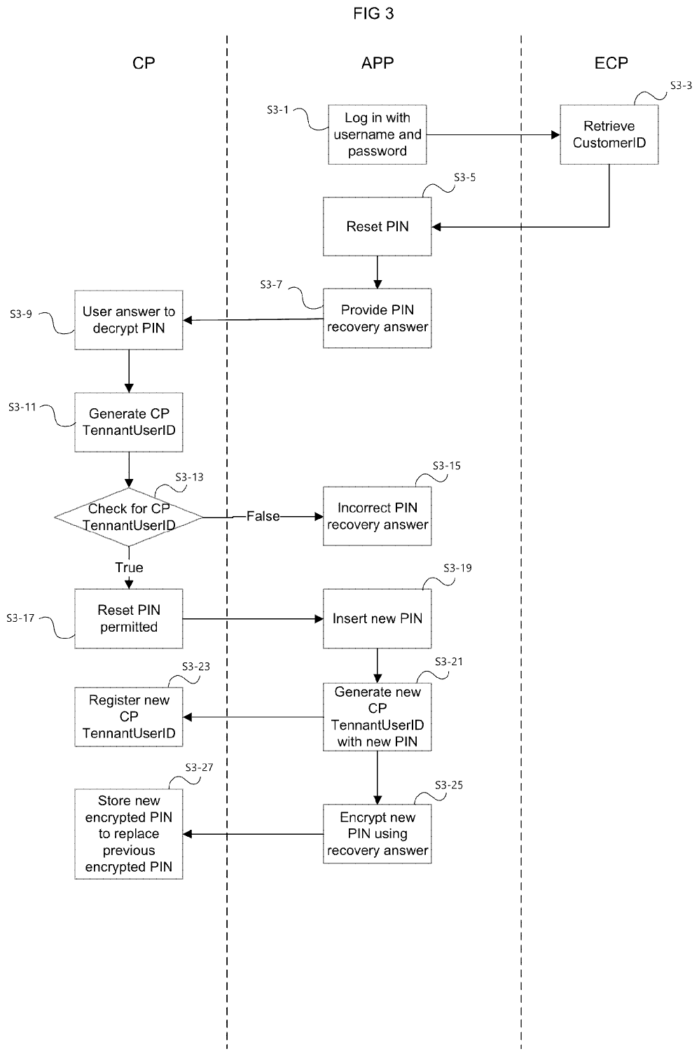

At this point, the process of configuring the connectivity platform for reception and storage of user-specific data shared from the user device is complete. By this approach, the identify of a particular user can be obscured from the connectivity platform while still permitting the shared user-specific data to be stored on a per-user basis. Optionally, the approach may have provided for later recovery of the user-set code in case the user were to forget the user-set code (such a recovery approach is described below with reference to FIG. 3). In addition, by adopting such a storage methodology for shared user-specific data, the user may retrieve any such shared data for future reference if desired, as is described hereunder.

Returning to FIG. 2, if at step S2-5 it was determined that the EverLogged field is set to True, this indicates that the process for creating and registering a CP TennantUserID for storage of shared user-specific data on an anonymised basis has already been completed. In this case however, a user may wish to retrieve some or all of their user-specific data from the connectivity platform. Accordingly, at step S2-23, the user is invited to enter the previously-set PIN (user-set code). This is then used (as in step S5-15) to generate the CP TennantUserID from the retrieved CustomerID and the entered user-set code at step S5-25 using the user-set code as a salt for hashing the CustomerID.

The CP TennantUserID is then provided by the user device to the connectivity platform so that the connectivity platform can check at step S2-27 whether the received CP TennantUserID is already registered in the connectivity platform. If the CP TennantUserID is already registered (e.g. the registration status of the received CP TennantUserID is true) then the connectivity platform can continue to, for example, retrieve any stored user-specific data that it has already received in association with that CP TennantUserID. Instead of or in addition to a data retrieval request, this same approach could be used to edit the already stored-data and/or delete the already stored data associated with that TennantUserID.

On the other hand, if it is determined the at step S2-27 that the received CP TennantUserID is not already registered in the connectivity platform (e.g. the registration status of the received CP TennantUserID is false) then the connectivity platform can return an error to the user device indicating (Step S2-31) that the CP TennantUserID is not found. Because the CP TennantUserID is generated in a repeatable manner from the CustomerID and the user-set code, and as the Customer-ID is retrieved based on a successful user login to the operator platform along with the EverLogged status, such an error of a not-found CP TennantUserID is known to indicate that the user-set code (PIN) that was entered at step S2-23 was incorrect.

At this point, it is understood how the CP TennantUserID can be re-created after initial generation and registration with the connectivity platform for use by the user in accessing (and/or editing, and/or deleting) any user-specific data that has already been shared from the user device to the connectivity platform. In some implementations, in addition to or instead of this process being used to access (and/or edit, and/or delete) any user-specific data that has already been shared from the user device to the connectivity platform, this process may be used each time the user device shares further user-specific data to the connectivity platform. Instead of being used each time such data is shared, the process may instead be triggered after a certain number of data sharing events or after a certain elapsed time since the last time that the process was followed.

As will be appreciated, a user may wish to recover a forgotten or lost user-set code (for example if unable to remember the user-set code to enter at step S2-23, or after receiving an error message at step S2-31). Such a process (which utilises the recovery answer optionally provided at step S2-9) is now explained with reference to FIG. 3.

FIG. 3 shows a process by which a lost user code may be reset while respecting anonymization of shared data. In the present examples, the recovery of a user-set code is interpreted as a process by which a user-set code may be reset following the user evidencing knowledge that enables the user-set code to be tested.

First, at step S3-1, the user device logs 12 in to the operator platform (ECP) 18 in the same manner as explained with reference to step S2-1 above. Responsive to such login, the operator platform retrieves the CustomerID for that user at step S3-3 (in the same manner as explained with reference to step S2-3 above). Following receipt of this CustomerID by the user device, the Reset PIN (reset user-set code) operation can commence as indicated by step S3-5. As will be appreciated, if the user wishes to reset the user-set-code as a result of being unable to remember the user-set code to enter at step S2-23, or after receiving an error message at step S2-31, the user may be provided with the option to move directly to the Reset PIN process from either of those steps in the flow shown in FIG. 2. In such examples, it may be omitted to re-login to the operator platform to retrieve the CustomerID as this will have already been performed at the commencement of the flow in FIG. 2. In some examples however it may be appropriate to force a re-login and CustomerID retrieval as an immediate prerequisite of the Reset PIN process.

Regardless of the precise preliminaries, once the CustomerID is satisfactorily known to the user device, the user device prompts at step S3-7 the user to enter the recovery answer that was provided as part of registering for data storage in the flow of FIG. 2. Such prompt may include offering to the user the same prompt-question(s) as were offered as the prompt for previously creating the recovery answer. This recovery answer and the CustomerID are then provided to the connectivity platform so that the provided answer can be used to decrypt at step S3-9 the stored encrypted user set code (as previously stored at step S2-13). The operator system then uses the CustomerID and decrypted user-set code to generate the CP TennantUserID using the same process that was used for this generation at steps S2-15 and S2-25.

Having re-created that CP TennantUserID, this is then checked at step S5-13 to see if the generated CP TennantUserID is already registered at the connectivity platform. In order to simplify this check, in examples where the UUID has been shared to the user device, the UUID could be provided from the user device to the connectivity platform with the CustomerID and recovery answer so that the generated CO TennantUserID only needs checking against any CP TennantUserID values associated with that UUID. could also be sent to the connectivity platform so as to simplify the lookup Until this check is done, it is not known whether the recovery answer was correct. This is because using the provided recovery answer to decrypt the stored encrypted user-set code may return a value that can be processed as though it were a user-set code regardless of whether the decryption resulted in retrieving the same user-set code as was originally created at step S2-7.

Accordingly, it is possible that the provided recovery answer is incorrect such that the decryption returned a wrong user-set code so as to result in generating a CP TennantUserID that is incorrect. In such situation, the check at step S5-13 returns a result indicating that no such CP TennantUserID is registered, such that a value of false may be provided to the user device. Accordingly, the user device will know (S3-15) that an incorrect recovery answer was provided, which information may be provided to the user by the user device. At this point, the recovery/reset of the user-set code has failed and the process may end, although some implementations may allow for further attempts to remember the correct recovery answer. In line with data security practices, the system may allow only a limited number of further attempts.

If on the other hand, the check at step S2-13 indicates that the generated CP TennantUserID is already registered (a true status of registration) then a reset of user-provided code is permitted and an associated reset is initiated as indicated by step S3-17. Once the user device has been informed that this reset of the user-set code is permitted, the user device invites the user to input a new user-set code (PIN) at step S3-19. Such a new user-set code would be expected to be subject to the same constraining specified properties as the user-set code previously set at step S2-7, although the constraining specified properties could be changed between generation of the original user-set code at step S2-7 and setting a new user-set code at step S5-19.

The new user-set code is then used in combination with the CustomerID at step S3-21 to generate a new CP TennantUserID. This new CP TennantUserID is then provided to the connectivity platform to register the new CP TennantUserID for data storage (S3-23). In some implementations where a UUID is used by the connectivity platform, the connectivity platform may record the new CP TennantUserID against the same UUID as was used for the previous CP TennantUserID (this being possible for example if the reset of PIN that was started at S3-17 is associated with some form of identifier such as a session token that links the new CP TennantUserID to the previous CP TennantUserID as checked at step S3-13). If such approach of consistent UUID allocation is used, then the user will be able to use the new user-set code to access/edit/delete shared user-specific data that was already shared using the previous CP TennantUserID.

In addition, so as to provide for a further reset operation in the event that the user again loses or forgets the new user-set code, the new user-set code can be encrypted using the recovery answer at step S3-25 for storage to the operator platform at step S3-27.

At this point, the process for resetting a user-set code after an original user-set code has been lost or forgotten is complete. With the new user-set code, a user can again conduct steps S2-23 to S2-29 as previously described.

In the above, it is mentioned that as part of the process for resetting the user-set code the CustomerID is provided to the connectivity platform. In order to avoid the stored data becoming linked to that CustomerID, the relevant steps are performed by one or more processes in the connectivity platform that are maintained separate in memory resources from any processes that handle storage of shared user-specific data. For instance, the steps S3-9 to S3-17 may be operated by a distinct process that shares no memory resources with data storage operations. For further separation, such process may run wholly in volatile memory such that at no point is the CustomerID stored persistently at the connectivity platform.

Accordingly it will be understood that the present teachings provide a complete solution for sharing of user-specific data in an anonymised manner, for management of previously shared and/or to be stored user-specific data, and for recovery of a user set code that is used as part of the anonymization process. The skilled reader is therefore equipped by the present teachings to realise a variety of possible implementations that embody these approaches.

Therefore from the above it will be appreciated that the data storage properties of the various devices and systems is as follows. Aerosol provision device 14 stores data relating to its use for aerosol provision, including for example operation settings and collected usage data. User device 12 stores data received from the aerosol provision device (including for example collected usage data) and also stores other usage data (such as position measurements and/or timestamps relating to the collected usage data from the aerosol provision device), and further stores data relating to interaction with the operator platform and/or the connectivity platform (including for example any of username for login to operator platform, password for login to operator platform, session token for an operator platform login session, CustomerID, CP TennantUserID, login credentials for access to connectivity platform, session token for access to connectivity platform, and UUID). Connectivity platform 16 stores shared user-specific data as shared from the user device 12, in addition to data required to enable such data to be stored and managed on a per-user (albeit anonymised) basis (including for example any of CP TennantUserID, UUID, any data required for testing login credentials needed for user login to the connectivity platform), and may also store user-set code recovery information in the form of the encrypted user-set code. Operator platform 18 stores data relating to use and management of the user's account, including for example, data for testing login credentials, CustomerID, EverLogged status and various personally identifiable information relating to the user account (such as name, address, payment details for any fee-based services obtainable via the operator platform, or the like).

Although it has been described that the system utilises an operator platform which stores the CustomerID and EverLogged status, in alternative implementations (for example where there is no login account system for users of the aerosol provision device) the CustomerID and EverLogged status could be maintained in the user device and the entire arrangement used without an operator platform being provided/involved.

Although it has been described above that the user device is running software (sometimes termed an application and/or an app) for providing the above-functionalities, in some implementations the user device functionality may be provided by way of a webapp instead of an application/app running on the device. In such implementations, the webapp may be hosted for example by the connectivity platform, the operator platform or a separate platform. The same functionality as above would be provided by the webapp, although the webapp would typically cause the CP TennantUserID to be stored locally on the mobile device so as to be available consistently for any later use.

In the above, the CustomerID is described as being an identifier that represents the identify of a user and which can be used utilised by the user to access a platform provided by a supplier of the aerosol provision device and/or operator of online services relating to the aerosol provision device. It will be appreciated that such an identifier can take a number of forms. So as to provide for consistency of data management for a given user, it may be appropriate for the CustomerID to be an identifier applied by the operator platform in a manner such that each user of the operator platform has a different CustomerID (in other words, the CustomerID is unique to the user within the environment in which the CustomerID is assigned and used). In some implementations, it may instead be appropriate to use as the CustomerID a property of the user, such as the user's email address as used to register with the operator platform.

In the above, the CP TennantUserID is described as a new user-specific identified which can be associated to shared user-specific data without providing a link to the actual specific user from which the data is provided. Although it is described above that the CP TennantUserID created by hashing the CustomerID using the user-set code as a salt, other approaches for determining the CP TennantUserID may instead be adopted. For example, in some implementations, for instance if it is undesirable to provide an option to reset the user-set code if lost or forgotten, the CP TennantUserID may be made by hashing the CustomerID without using a salt. In such implementations a mechanism may be required to intervene in case a hash collision could occur such as to provide the same CP TennantUserID for two different CustomerIDs, as the present approaches operate on the basis that each CP TennantUserID is related to a corresponding individual user. For example, in other implementations, the CP TennantUserID could be a user-selected code and this in-effect a long user-set code or password (i.e. long-enough to provide uniqueness of CP TennantUserID as between different users).

As has been mentioned above, the storing of an encrypted form of the user-set code is not required in all implementations. In particular, this is provided for instances in which the implementation is to be configured for recovery of the user-set code. If no such option is provided, then it is not necessary to store the encrypted copy of the user-set code, and thus also the recovery answer would not be required.

Further, although it has been described above that the encrypted copy of the user-set code is stored at the connectivity platform, this could instead be stored at the user device or at the operator platform.

Indeed, it is also possible (regardless of where the encrypted copy of the user-set code is stored) to have the decryption of the stored user set code (step S3-9) and the generation of the CP TennantUserID from the decrypted PIN (and the known CustomerID) performed at the user device. This would provide that the CustomerID never reaches the connectivity platform, as the CustomerID could remain at the user device and then after generation of the CP TennantUserID from the decrypted PIN at step S3-11 that generated CP TennantUserID could be provided to the connectivity platform to perform step S3-13. In some such implementations, if the UUID has been shared from the connectivity platform to the user device, the UUID could be used in association with the generated CP TennantUserID to assist in the lookup at step S3-13. Such an approach may increase the perception of privacy by the user as the CustomerID would not be sent (even temporarily) to the customer platform, but overall data security might be lower if the user device is deemed a less secure environment than the connectivity platform.

Although it has been described above that the user device is used to collect data from the aerosol provision device and then share that data with the connectivity platform, in some implementations the functionality of the aerosol provision device 14 and user device 12 may be combined in a single connected aerosol provision device. Such a connected aerosol provision device would provide the aerosol generation functions and data logging functions of the aerosol provision device 14, and also the functionality for communicating with and interfacing with the connectivity platform 16 and the operator platform 18. In such implementations, all references above to each of the aerosol provision device 14 and user device 12 would be understood to relate instead to the connected aerosol provision device.

Although it has been described above that the data collected by the user device is shared as user-specific data, the user device may in some implementations pre-filter or pre-edit the data before sharing. Such approaches may be used to remove data that might be usable to defeat the anonymization o the user-specific data that is provided by the use of the hashed-relation between CustomerID and CP TennantUserID. For instance, information such as locations of certain measurements may be removed so as not to link the anonymised data to a particular location (such as a home or work location) of the user. Other data entries may also be removed as appropriate to maintaining the value of the anonymization approach.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A method comprising:
collecting, at a device, user-specific data relating to an aerosol provision device of a user;
transmitting the user-specific data to a remote system in association with a hashed user ID for the user of the aerosol provision device, wherein the hashed user ID is not usable to identify the user.

2. The method of claim 1, wherein the hashed user ID is created from a hash of a customer ID that is usable to identify the user.

3. (canceled)

4. The method of claim 2, wherein creating the hashed user ID comprises using a salt comprising the customer ID and a user-set code.

5. The method of claim 4, further comprising transmitting an encrypted copy of the user-set code to a connectivity platform.

6. The method of claim 5, wherein encryption of the user-set code is based upon a user-set security term.

7. The method of claim 6, further comprising providing a mechanism for a user to reset the user-set code comprising:
inviting a user to enter the user-set security term;
transmitting the user-set security term and the customer ID to the connectivity platform;
decrypting the stored encrypted user-set code using user-set security term;
hashing the customer ID using the customer ID and the decrypted user-set code as salt;
comparing the hash result against a record of known hashed user-IDs; and
transmitting to the device a message indicating that a new user-set code can now be created.

8.-10. (canceled)

11. The method of claim 1, further comprising retrieving data from the remote system by: transmitting a query comprising the hashed customer ID; and receiving the transmitted user-specific data.

12.-15. (canceled)

16. A user device configured to:
collect user-specific data relating to an aerosol provision device of a user;
transmit the user-specific data to a remote system in association with a hashed user ID for the user of the aerosol provision device, wherein the hashed user ID is not usable to identify the user.

17. The user device of claim 16, further configured to generate the hashed user ID from a hash of a customer ID that is usable to identify the user.

18. (canceled)

19. The user device of claim 17, further configured to generate the hashed user ID using a salt comprising the customer ID and a user-set code.

20. The user device of claim 19, further configured to transmit an encrypted copy of the user-set code to a connectivity platform.

21. The user device of claim 20, wherein encryption of the user-set code is based upon a user-set security term.

22. The user device of claim 21, further configured to provide a mechanism for a user to reset the user-set code comprising:
inviting a user to enter the user-set security term;
transmitting the entered user-set security term and the customer ID to the connectivity platform for decryption of the stored encrypted user-set code using the entered user-set security term; and
receiving a message indicating that a new user-set code can be created, based on a hash of the customer ID using the decrypted user-set code as salt matching a record of known hashed user IDs at the connectivity platform.

23.-25. (canceled)

26. The user device of claim 16, further configured to retrieve data from the remote system by: transmitting a query comprising the hashed user ID; and receiving the transmitted user-specific data.

27.-29. (canceled)

30. The user device of claim 16, wherein the user device and the aerosol provision device are integrated into a single device.

31. (canceled)

32. A data management system, comprising a user device and a connectivity platform, wherein the user device is configured to collect user-specific data relating to an aerosol provision device of a user, and to transmit the user-specific data to the connectivity platform in association with a hashed user ID for the user of the aerosol provision device, wherein the hashed user ID is not usable to identify the user.

33. The data management system of claim 32, wherein the user device is further configured to generate the hashed user ID from a hash of a customer ID that is usable to identify the user.

34. (canceled)

35. The data management system of claim 33, wherein the user device is further configured to generate the hashed user ID using a salt comprising the customer ID and a user-set code.

36. The data management system of claim 35, further configured to transmit an encrypted copy of the user-set code to the connectivity platform, and the connectivity platform is further configured to store the encrypted copy of the user-set code.

37.-41. (canceled)

42. The data management system of claim 32, wherein the user device is further configured to retrieve data from the remote system by: transmitting a query comprising the hashed user ID; and the connectivity platform is configured to test the hashed user ID against records of hashed user IDs already used to store data, and to provide to the user device stored data corresponding to the hashed user ID.

43.-47. (canceled)
